(19) United States
(12) Patent Application Publication
(10) Pub. No.: US 2018/0004931 A1
(43) Pub. Date: Jan. 4, 2018

(54) PROCESS MANAGEMENT

(71) Applicant: Intel Corporation, Santa Clara, CA (US)

(72) Inventors: Michael E. Kounavis, Portland, OR (US); David M. Durham, Beaverton, OR (US)

(73) Assignee: Intel Corporation, Santa Clara, CA (US)

(21) Appl. No.: 15/201,399

(22) Filed: Jul. 2, 2016

(51) Int. Cl. G06F 21/44; G06F 12/14

(52) U.S. Cl. CPC G06F 21/44; G06F 12/14; G06F 2212/1052

(57) ABSTRACT

Particular embodiments described herein provide for a network element that can be configured to determine that an application begins to execute, receive credentials for the application, where the credentials are located in an immediate field of the application, receive a request from the application to access a secure resource, and block access to the secure resource if the credentials for the application do not allow the application to access the secure resource. In an example, the credentials include a public key and a private key.

### TECHNICAL FIELD

This disclosure relates in general to the field of information security, and more particularly, to process management.

### BACKGROUND

The field of network and cloud security has become increasingly important in today's society. The Internet has enabled interconnection of different computer networks all over the world. In particular, the Internet provides a medium for exchanging data between different users connected to different computer networks via various types of client devices. While the use of the Internet has transformed business and personal communications, it has also been used as a vehicle for malicious operators to gain unauthorized access to computers and computer networks and for intentional or inadvertent disclosure of sensitive information.

Malicious software (“malware”) that infects a host computer may be able to perform any number of malicious actions, such as stealing sensitive information from a business or individual associated with the host computer, propagating to other host computers, assisting with distributed denial of service attacks, sending out spam or malicious emails from the host computer, etc. Hence there is a need to protect systems from malware.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a communication system for process management, in accordance with an embodiment of the present disclosure;

FIG. 2 is a simplified block diagram of a portion of a communication system for process management, in accordance with an embodiment of the present disclosure;

FIG. 3 is a simplified block diagram of a portion of a communication system for process management, in accordance with an embodiment of the present disclosure;

FIG. 4 is a simplified flowchart illustrating potential operations that may be associated with the communication system in accordance with an embodiment;

FIG. 5 is a simplified flowchart illustrating potential operations that may be associated with the communication system in accordance with an embodiment;

FIG. 6 is a block diagram illustrating an example computing system that is arranged in a point-to-point configuration in accordance with an embodiment;

FIG. 7 is a simplified block diagram associated with an example ecosystem system on chip (SOC) of the present disclosure; and

FIG. 8 is a block diagram illustrating an example processor core in accordance with an embodiment.

The FIGURES of the drawings are not necessarily drawn to scale, as their dimensions can be varied considerably without departing from the scope of the present disclosure.

### DETAILED DESCRIPTION OF EXAMPLE EMBODIMENTS

### Example Embodiments

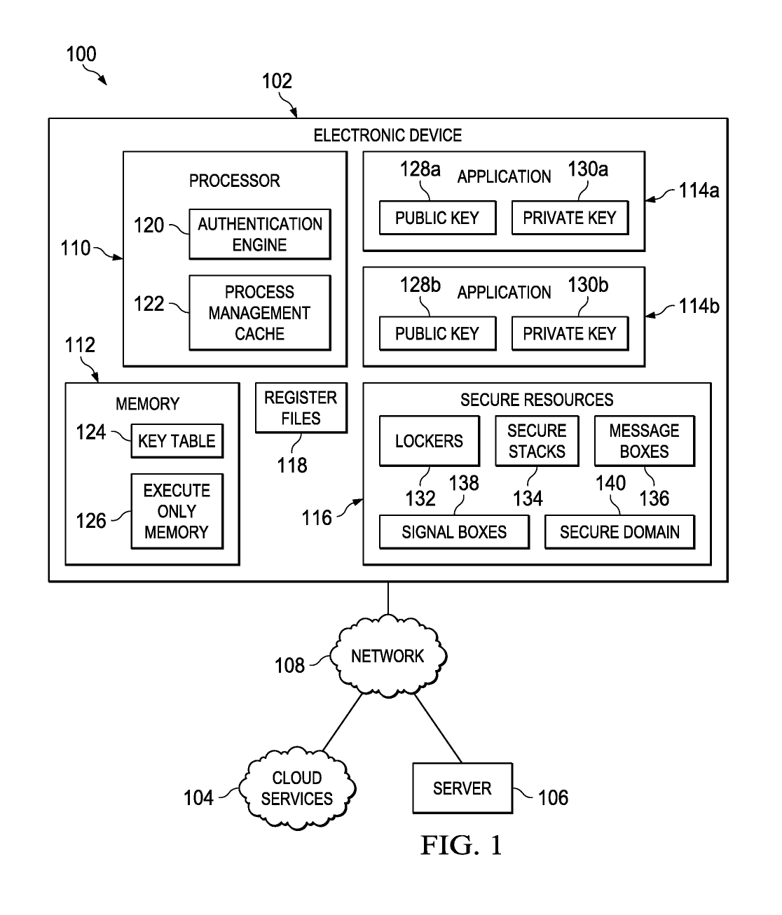

FIG. 1 is a simplified block diagram of a communication system 100 for process management, in accordance with an embodiment of the present disclosure. As illustrated in FIG. 1, communication system 100 can include electronic device 102, cloud services 104, and a server 106. Electronic device 102 can include a processor 110, memory 112, one or more applications 114a and 114b, secure resources 116, and register files 118. Processor 110 can include an authentication engine 120 and a process management cache 122. Memory 112 can include a key table 124 and execute only memory 126. Application 114a can include a public key 128a and a private key 130a. Application 114b can include a public key 128b and a private key 130b. Secure resources 116 can include lockers 132, secure stacks 134, message boxes 136, signal boxes 138, and a secure domain 140. Electronic device 102, cloud services 104, and server 106 may be in communication using network 108. Application 114a and 114b may each be an application or a process.

Elements of FIG. 1 may be coupled to one another through one or more interfaces employing any suitable connections (wired or wireless), which provide viable pathways for network (e.g., network 108, etc.) communications. Additionally, any one or more of these elements of FIG. 1 may be combined or removed from the architecture based on particular configuration needs. Communication system 100 may include a configuration capable of transmission control protocol/Internet protocol (TCP/IP) communications for the transmission or reception of packets in a network. Communication system 100 may also operate in conjunction with a user datagram protocol/IP (UDP/IP) or any other suitable protocol where appropriate and based on particular needs.

For purposes of illustrating certain example techniques of communication system 100, it is important to understand the communications that may be traversing the network environment. The following foundational information may be viewed as a basis from which the present disclosure may be properly explained.

Some electronic devices can be organized using hierarchical protection domains or protection rings. The protection rings can provide different levels of access to resources and are mechanisms to protect data and functionality from faults by improving fault tolerance and by providing computer security. For example, a protection ring is one of two or more hierarchical levels or layers of privilege within the architecture of a computer system. The layers of privilege are generally hardware-enforced by some CPU architectures that provide different CPU modes at the hardware or microcode level. The rings are typically arranged in a hierarchy from most privileged (most trusted, usually numbered zero) to least privileged (least trusted, usually with the highest ring number). On most operating systems, ring 0 is the level with the most privileges and interacts most directly with the physical hardware such as the CPU and memory. Special gates between rings can be provided, realized in hardware or in software to allow an outer ring to access an inner ring's resources in a predefined manner, as opposed to allowing arbitrary usage. For example, malware running as a user program in ring 3 should be prevented from turning on a web camera without informing the user, since hardware access is typically a ring 1 function reserved for device drivers.

Malicious software (“malware”) that infects a host computer may be able to perform any number of malicious actions, such as stealing sensitive information from a business or individual associated with the host computer, propagating to other host computers, assisting with distributed denial of service attacks, sending out spam or malicious emails from the host computer, etc. One method used to help identify and prevent malware involves use of secure process management, especially monitoring ring 3 functions. The term “process management” is to include to a wide range of CPU, OS and ring 3 functions that may include interrupts, exception handling, DMA memory transfers, translation cache (TLB) management, inter-process communication, process state management, virtual machine monitoring, and secure memory enclave management. However, supporting all these functions in a secure manner can be relatively expensive because it requires either complex management tasks (e.g., ring transitions) or the execution of compute-intensive cryptographic algorithms.

A communication system for process management, as outlined in FIG. 1, can resolve these issues (and others). Communication system 100 may be configured such that processes can prove their identity by carrying credentials in the form of immediate fields in the code of the application or process. The term “immediate fields” includes a constant operand included in the instruction code of the application or process. In an example, cryptographic mechanisms do not need to run every time privileged operations are performed, but only when credentials are established. The credentials can include asymmetric keys, and specifically private-public key pairs (e.g., public key 128a and private key 130a). Once credentials are established, they can be carried by the instructions in the form of immediate fields. Thus, the credentials can be presented by instructions at process management time and only need be compared against credentials stored inside the CPU boundary (e.g., authentication engine 120), instead of being verified cryptographically. As a result, the execution of relatively expensive cryptographic algorithms can be avoided as a simple matching operation can be relatively faster and significantly less expensive than algorithms such as RSA or ECC-DSA.

Currently, processor hardware and the OS are used to support the transition between rings of protection at the expense of performance and cost. Further, additional security mechanisms for protecting the access to content or establishing trust come at additional cost such as the latency to measure the input code when a secure domain or enclave is established. Communication system 100 can be configured such that a root of trust is no longer a privileged process but where the root of trust is the CPU itself and especially the instruction set architecture (ISA). In an example, process credentials can be cryptographic keys which are provided as immediate fields in the code of an application (e.g., public key 128a and private key 130 can be provided in the code of application 114a). This allows for the replacement of rings of protection by more flexible credential-associated privileges. For example, communication system 100 can allow for multiple sets of privileges that are diverse, dedicated for a specific process task, can support a range of functions of an OS or a VMM, may be flexible, can change at run time, etc. In addition, each set of privileges can coexist with one or more other sets of privileges.

In addition, process credentials can be used for easily accessing traditional as well as new types of hardware resources such as in-silicon lockers, stacks, message boxes etc. Such hardware resources enable code execution models that are considered costly today such as tightly-coupled parallel code execution across CPU cores/threads-without incurring the traditional overheads of inter-core communication (e.g. parallel CRC or AES-GCM computations).

In a specific example, communication system 100 can be configured with a framework based on the ability of the CISC ISA to carry immediate fields in the code. Currently, immediate fields do not generally exceed 64 bits in size. However, extensions to the ISA could be used where 128, 256, or 512 bit immediate fields could be introduced, thus allowing for larger immediate fields. The larger immediate fields could be carried by vector instructions (e.g., SSE, AVX-256, AVX-512) or other scalar instructions.

The CISC ISA can be configured for setting memory areas as execute only (e.g., execute only memory 126). Code placed in the execute only memory can be executed but cannot be read. In this way immediate fields can carry secrets where confidentiality is protected. The framework can also include the use of asymmetric key cryptography for process management (e.g., public key 128a and private key 130a pairs). Asymmetric keys can be placed in immediate fields, carried by code which runs in an execute-only mode and used for performing privileged operations such as accessing system resources which otherwise would only be accessible by ring 0 code.

Communication system 100 can be configured to include secure resources 116 that can provide a range of new processor resources such as lockers (e.g., lockers 132), secure stacks (e.g., secure stacks 134), messages boxes (e.g., message boxes 136), signal boxes (e.g., signal boxes 138), etc. as well as one or more secure domains (e.g., secure domain 140). The term “secure domains” generally includes secure memory areas, memory enclaves, secure state repositories, translation lookaside buffers, trusted execution environments, etc. Each of these resources can be realized using dedicated register files (e.g. register files 118) that are only accessible if the credentials provided by the instructions that request access to a resource matches with the credentials of the process or processes that own the resources, or the processes which are allowed to access the resources.

In an example, communication system 100 can be configured such that almost every program, process, or application (e.g., OS, VMM, or application executable) can be associated with a public and private key pair. Public and private keys can be carried by code in the form of immediate fields. When an application (or process) accesses a secured resource or performs a privileged operation the application uses its credentials which are placed in the immediate fields. For example, a private key could be directly used for accessing a locker where an application stores its state before the program execution is transferred to another process. In this case, the locker could act as a quickly accessible process control block. The root of trust or authentication engine (e.g., authentication engine 120) can compares the private key provided in the immediate field against the in-CPU stored private key (e.g., in process management cache 122) of the process that owns the resource or is allowed to perform the operation. If the keys are equal or match, then access is granted, otherwise access is not granted. In a specific example, the comparisons can require a small number of XOR gates that are equal to the length of the key.

The use of asymmetric key cryptography for process management can virtually eliminate rings of privileges and ring transitions. Currently, in order for an application to request access to some secure resource or initiate a privileged operation, a ring transition is required. In an example, communication system 100 can be configured to access the resource or perform the operation only through a system call. For example, an application may first establish its credentials and then the application can use the credentials to perform the desired privileged operation or request access to the desired resource, interacting directly with the CPU hardware. Such an interaction can involve presenting the appropriate private key to the CPU as an immediate field via an appropriate new instruction. Once access is granted, the application can continue accessing the resource with its private key present in immediate fields. In this way, no ring transitions are involved.

As a result, model ring transitions can be replaced by privilege set transitions. As there are currently rings of protection, several sets of privileges associated with different instructions, resources, or management operations can be implemented. Contrary to rings, privilege sets can be managed by process credentials in the ISA and can be more flexible, thereby potentially reducing the cost of process management functions. In an example, an application can use its own in-silicon locker for storing its state (e.g., process control block) before a context switch. Similarly, the application could modify the contents of a translation cache or a translation lookaside buffer (TLB) before switching out. In this case, the control flow could be directly transferred to another application bypassing a ring 0 process. Another difference between rings of protection and privilege sets is that, whereas rings demonstrate a clear distinction about which privileges are associated with each ring, privilege sets and could be associated with arbitrary privileges, depending on application needs and overall system requirements. The exact privileges associated with a set could be set in many different ways including using the BIOS services.

The public key (e.g., public key 128a) of a program is known to every other application and can be used for inter-process communication, message passing, secure interrupts, or privilege set transitions. The private key (e.g., private key 130a) is known to only one single program and the program's owner and is embedded in the code in the form of immediate fields. For example, the private and public keys may be associated with a software product's serial number. In another example, a compiler may support the generation of a public-private key pair and the insertion of such key pair in the code.

When registering a program with a computer system, the BIOS and the program's credentials (e.g., the private key) may be used to associate the program with privileges. Privileges may include, but are not be limited to, instructions the program may be allowed to execute, hardware resources to access, special purpose memory enclave access privileges, translation cache access privileges or page table access privileges. Privilege information may be stored securely in some non-volatile memory and may be cached inside the process package. Instruction access information may be encoded in the form of a bit vector.

Process credentials can be stored in a process management cache (e.g., process management cache 122). The process management cache can be realized as a fully associated cache memory, consisting of entries structured according to the examples described herein. Each entry can include a public-private key pair, a process ID (deriving from the key pair and a global CPU counter), information about the process state and privileges and information about resources owned (e.g., in-silicon locker IDs). In one example, realization of the process management cache can be inside the CPU boundary. In another example, realization of the process management cache may reside fully or partially outside the CPU boundary in some dedicated, encrypted memory area. In other examples, realization of the fields of each entry of the process management cache can be encoded in such a way so that they occupy a fixed number of registers. In yet other examples, realization of each entry may occupy a variable number of registers. The process management cache may be searched using one or more fields and return a single or multiple entries that match with the input fields.

When a new application begins executing or when a process that has been switched out resumes execution, the credentials of the application/process are presented to the processor. Credentials have the form of a public-private key pair and a special credential establishment instruction may be used for this purpose. The credentials presented are then used for searching the process management cache and if at least one entry is found, then the credentials are established. Presence of at least one entry with the supplied public-private key pair in the process management cache can mean that the CPU has verified the validity of the pair before. If no entry is found in the process management cache, then the CPU verifies the validity of the supplied pair cryptographically. Cryptographic verification of a public-private key pair (e.g., verifying that the supplied public key matches with the supplied private key) can be done using known cryptographic algorithms such as RSA or ECC-DSA. If the verification is successful, then the credentials are established. If not, then a fault occurs and an exception is handled. When a new instance of an application begins executing or the credentials are established for the first time, a new entry is inserted into the process management cache.

The public-private key pair can be hashed together with some global system counter and other state information to create an ID for a process. All processes which are instances of the same program can share the same public-private key pair but use different process IDs. A process ID may be used internally inside the CPU package for process management, or, alternatively, it may be visible to the application and obtained using special instructions that require checking supplied credentials. The public-private key pair and process ID can be used in a range of different ways for accessing system resources and performing process management tasks.

A process presenting the appropriate private key may be allowed to perform privileged operations without transitioning to a different protection ring. Inter-process communication can be made faster as well. A process “A” can use its private key and the public key of a different process “B” to request information about the process “B's” presence in the system (e.g., process ID). Then process “A” can use this information to send process “B” a message.

If an attacker attempts to access an allocated resource with the wrong private key, then a fault or security event is raised. The attacker code can be flagged or processed where its features are extracted, its class is determined, and its determined class is marked as suspicious, thereby helping to avoid future attacks. An attacker may change the code and attempt a new attack. However, the new code may still be classified as malicious if the features of the new code place the code in the same learned class as the previous attempt.

In a specific example, performance efficient memory enclaves can be supported using key domain selectors or total memory encryption and per-application space and time key domains. Key domain selectors add application-specific information into an initialization vector, in addition to the spatial and temporal coordinates of an address. Key domain selectors may be derived from public-private key pairs. Different data structures may be associated with different key domain selectors. As a result, enclaves can be supported at the data structure granularity rather than the page granularity. Some domains may support replay protection using dedicated version trees. Other enclaves may support replay protection using time-domain specific key domain selectors.

Turning to the infrastructure of FIG. 1, communication system 100 in accordance with an example embodiment is shown. Generally, communication system 100 can be implemented in any type or topology of networks. Network 108 represents a series of points or nodes of interconnected communication paths for receiving and transmitting packets of information that propagate through communication system 100. Network 108 offers a communicative interface between nodes, and may be configured as any local area network (LAN), virtual local area network (VLAN), wide area network (WAN), wireless local area network (WLAN), metropolitan area network (MAN), Intranet, Extranet, virtual private network (VPN), and any other appropriate architecture or system that facilitates communications in a network environment, or any suitable combination thereof, including wired and/or wireless communication.

In communication system 100, network traffic, which is inclusive of packets, frames, signals, data, etc., can be sent and received according to any suitable communication messaging protocols. Suitable communication messaging protocols can include a multi-layered scheme such as Open Systems Interconnection (OSI) model, or any derivations or variants thereof (e.g., Transmission Control Protocol/Internet Protocol (TCP/IP), user datagram protocol/IP (UDP/IP)). Additionally, radio signal communications over a cellular network may also be provided in communication system 100. Suitable interfaces and infrastructure may be provided to enable communication with the cellular network.

The term “packet” as used herein, refers to a unit of data that can be routed between a source node and a destination node on a packet switched network. A packet includes a source network address and a destination network address. These network addresses can be Internet Protocol (IP) addresses in a TCP/IP messaging protocol. The term “data” as used herein, refers to any type of binary, numeric, voice, video, textual, or script data, or any type of source or object code, or any other suitable information in any appropriate format that may be communicated from one point to another in electronic devices and/or networks. Additionally, messages, requests, responses, and queries are forms of network traffic, and therefore, may comprise packets, frames, signals, data, etc.

In an example implementation, electronic device 102, cloud services 104, and server 106 are network elements, which are meant to encompass network appliances, servers, routers, switches, gateways, bridges, load balancers, processors, modules, or any other suitable device, component, element, or object operable to exchange information in a network environment. Network elements may include any suitable hardware, software, components, modules, or objects that facilitate the operations thereof, as well as suitable interfaces for receiving, transmitting, and/or otherwise communicating data or information in a network environment. This may be inclusive of appropriate algorithms and communication protocols that allow for the effective exchange of data or information.

In regards to the internal structure associated with communication system 100, each of electronic device 102, cloud services 104, and server 106 can include memory elements for storing information to be used in the operations outlined herein. Each of electronic device 102, cloud services 104, and server 106 may keep information in any suitable memory element (e.g., random access memory (RAM), read-only memory (ROM), erasable programmable ROM (EPROM), electrically erasable programmable ROM (EEPROM), application specific integrated circuit (ASIC), etc.), software, hardware, firmware, or in any other suitable component, device, element, or object where appropriate and based on particular needs. Any of the memory items discussed herein should be construed as being encompassed within the broad term ‘memory element.’ Moreover, the information being used, tracked, sent, or received in communication system 100 could be provided in any database, register, queue, table, cache, control list, or other storage structure, all of which can be referenced at any suitable timeframe. Any such storage options may also be included within the broad term ‘memory element’ as used herein.

In certain example implementations, the functions outlined herein may be implemented by logic encoded in one or more tangible media (e.g., embedded logic provided in an ASIC, digital signal processor (DSP) instructions, software (potentially inclusive of object code and source code) to be executed by a processor, or other similar machine, etc.), which may be inclusive of non-transitory computer-readable media. In some of these instances, memory elements can store data used for the operations described herein. This includes the memory elements being able to store software, logic, code, or processor instructions that are executed to carry out the activities described herein.

In an example implementation, network elements of communication system 100, such as electronic device 102, cloud services 104, and server 106 may include software modules (e.g., authentication engine 120) to achieve, or to foster, operations as outlined herein. These modules may be suitably combined in any appropriate manner, which may be based on particular configuration and/or provisioning needs. In example embodiments, such operations may be carried out by hardware, implemented externally to these elements, or included in some other network device to achieve the intended functionality. Furthermore, the modules can be implemented as software, hardware, firmware, or any suitable combination thereof. These elements may also include software (or reciprocating software) that can coordinate with other network elements in order to achieve the operations, as outlined herein.

Additionally, each of electronic device 102, cloud services 104, and server 106 may include a processor that can execute software or an algorithm to perform activities as discussed herein. A processor can execute any type of instructions associated with the data to achieve the operations detailed herein. In one example, the processors could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an EPROM, an EEPROM) or an ASIC that includes digital logic, software, code, electronic instructions, or any suitable combination thereof. Any of the potential processing elements, modules, and machines described herein should be construed as being encompassed within the broad term ‘processor.’

Electronic device 102 can be a network element and includes, for example, desktop computers, laptop computers, mobile devices, personal digital assistants, smartphones, tablets, or other similar devices. In other examples, electronic device 102 is a standalone electronic device. Cloud services 104 is configured to provide cloud services to electronic device 102. Cloud services 104 may generally be defined as the use of computing resources that are delivered as a service over a network, such as the Internet. Typically, compute, storage, and network resources are offered in a cloud infrastructure, effectively shifting the workload from a local network to the cloud network. Server 106 can be a network element such as a server or virtual server and can be associated with clients, customers, endpoints, or end users wishing to initiate a communication in communication system 100 via some network (e.g., network 108). The term ‘server’ is inclusive of devices used to serve the requests of clients and/or perform some computational task on behalf of clients within communication system 100.

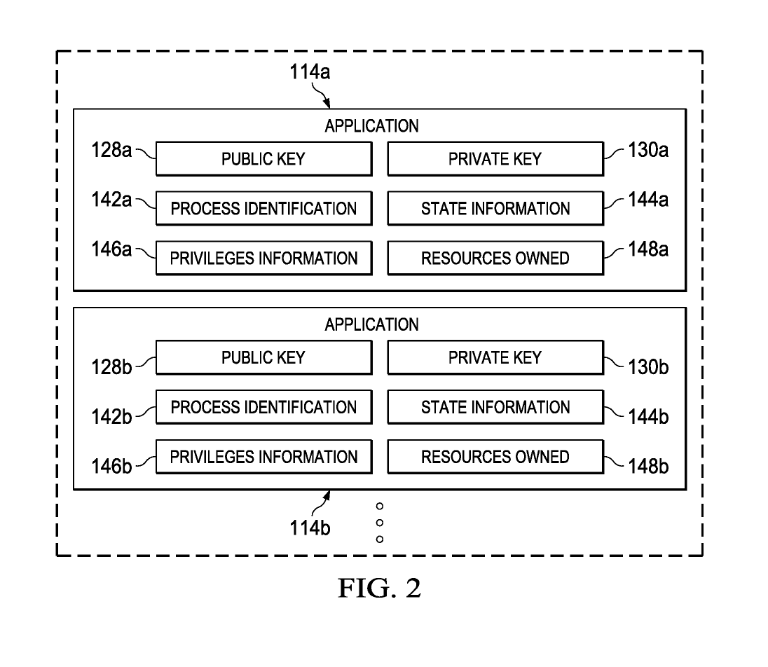

Turning to FIG. 2, FIG. 2 is a simplified block diagram of a portion of a communication system for process management, in accordance with an embodiment of the present disclosure. As illustrated in FIG. 2, application 114a can include public key 128a, private key 130a, process identification 142a, state information 144a, privileges information 146a, and resources owned 148a. In an example, public key 128a, private key 130a, process identification 142a, state information 144a, privileges information 146a, and resources owned 148a may be encoded in the form of a bit vector. Application 114b can include public key 128b, private key 130b, process identification 142b, state information 144b, privileges information 146b, and resources owned 148b. In an example, public key 128b, private key 130b, process identification 142b, state information 144b, privileges information 146b, and resources owned 148b may be encoded in the form of a bit vector.

In an example, the process identification 142a can include an identification of application 114a and process identification 142b can include identification of application 144b. State information 114a can include information about the state of application 114a. State information 114b can include information about the state of application 114b. For example, a state of the process could be associated with an in-silicon storage content of the general purpose registers as well as other state information. Privileges information 146a can include the privilege sets or privileges application 114a has and instructions application 114a is allowed to execute. Privileges information 146b can include the privilege sets or privileges application 114b has and instructions application 114b is allowed to execute. Resources owned 148a can specificity the silicon resources that application 114a is allowed to access or with what other processes application 114a is allowed to communicate. Resources owned 148b can specificity the silicon resources that application 114b is allowed to access or with what other processes application 114b is allowed to communicate.

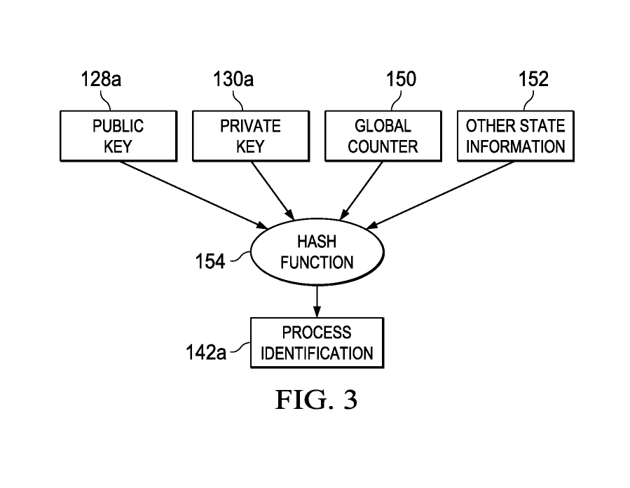

Turning to FIG. 3, FIG. 3 is a simplified block diagram of a portion of a communication system for process management, in accordance with an embodiment of the present disclosure. As illustrated in FIG. 3, process identification 142a can include a hash function 154 of public key 128a, private key 130a, a global counter 150, and other state information 152. Global counter 150 can be a time stamp. The hash of public key 128a, private key 130a, a global counter 150, and other state information 152 can create a unique process identification (e.g., different than process identification 142a). If application 114a makes a copy or clone of itself, each copy will have a unique process identification.

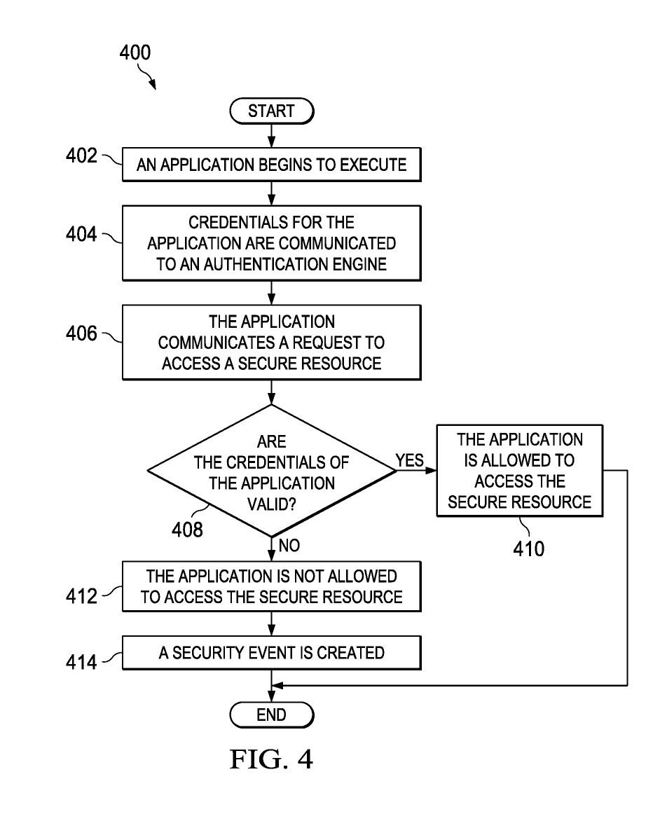

Turning to FIG. 4, FIG. 4 is an example flowchart illustrating possible operations of a flow 400 that may be associated with process management, in accordance with an embodiment. In an embodiment, one or more operations of flow 400 may be performed by authentication engine 120 and process management cache 122. At 402, an application begins to execute. At 404, credentials for the application are communicated to an authentication engine. At 406, the application communicates a request to access a secure resource. At 408, the system determines if the credentials of the application are valid. If the credentials of the application are valid, then the application is allowed to access the secure resource, as in 410. If the credentials of the application are not valid, then the application is not allowed to access the secure resource, as in 412. At 414, a security event is created. For examples, the security event can be to flag the application as potentially being or including malware.

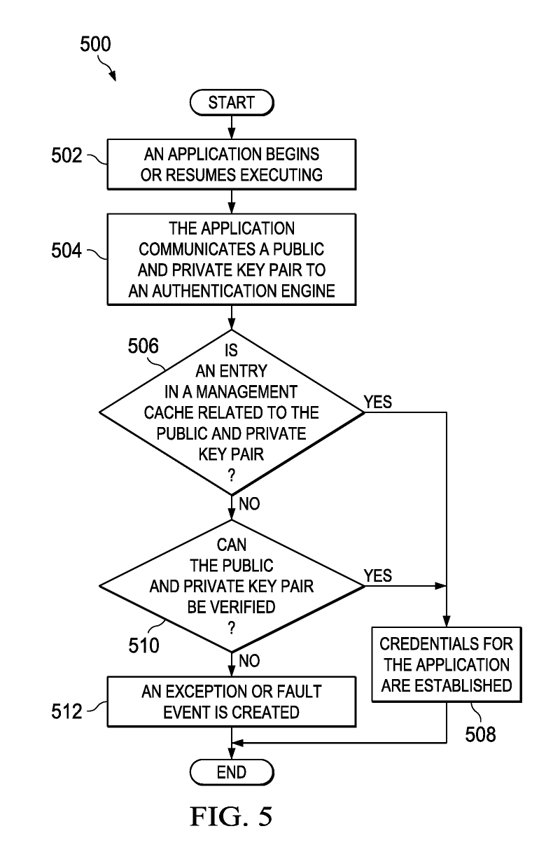

Turning to FIG. 5, FIG. 5 is an example flowchart illustrating possible operations of a flow 500 that may be associated with process management, in accordance with an embodiment. In an embodiment, one or more operations of flow 500 may be performed by authentication engine 120 and process management cache 122. At 502, an application begins or resumes executing. At 504, the application communicates a public and private key pair to an authentication engine. At 506, the system determines if an entry in a management cache is related to the public and private key pair. If an entry in a management cache is related to the public and private key pair, then credentials for the application are established, as in 508. If an entry in a management cache is not related to the public and private key pair, then the system determines if the public and private key pair can be verified, as in 510. If the public and private key pair can be verified, then credentials of the application are established, as in 508. If the public and private key pair cannot be verified, then an exception or fault event is created, as in 512. For example, the exception or fault even can cause the application to be analyzed for malware.

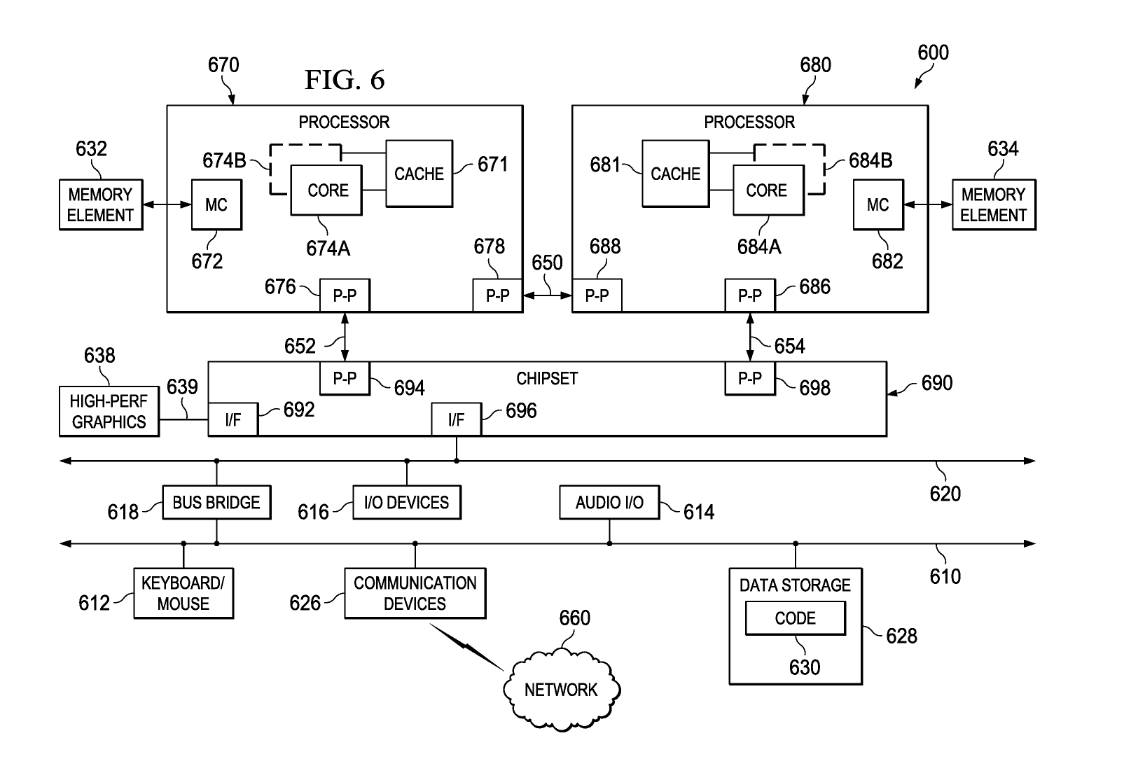

Turning to FIG. 6, FIG. 6 illustrates a computing system 600 that is arranged in a point-to-point (PtP) configuration according to an embodiment. In particular, FIG. 6 shows a system where processors, memory, and input/output devices are interconnected by a number of point-to-point interfaces. Generally, one or more of the network elements of communication system 100 may be configured in the same or similar manner as computing system 600. More specifically, authentication engine 120 and process management cache 122 can be configured in the same or similar manner as computing system 600.

As illustrated in FIG. 6, system 600 may include several processors, of which only two, processors 670 and 680, are shown for clarity. While two processors 670 and 680 are shown, it is to be understood that an embodiment of system 600 may also include only one such processor. Processors 670 and 680 may each include a set of cores (i.e., processor cores 674A and 674B and processor cores 684A and 684B) to execute multiple threads of a program. The cores may be configured to execute instruction code in a manner similar to that discussed above with reference to FIGS. 1-5. Each processor 670, 680 may include at least one shared cache 671, 681. Shared caches 671, 681 may store data (e.g., instructions) that are utilized by one or more components of processors 670, 680, such as processor cores 674 and 684.

Processors 670 and 680 may also each include integrated memory controller logic (MC) 672 and 682 to communicate with memory elements 632 and 634. Memory elements 632 and/or 634 may store various data used by processors 670 and 680. In alternative embodiments, memory controller logic 672 and 682 may be discrete logic separate from processors 670 and 680.

Processors 670 and 680 may be any type of processor and may exchange data via a point-to-point (PtP) interface 650 using point-to-point interface circuits 678 and 688, respectively. Processors 670 and 680 may each exchange data with a chipset 690 via individual point-to-point interfaces 652 and 654 using point-to-point interface circuits 676, 686, 694, and 698. Chipset 690 may also exchange data with a high-performance graphics circuit 638 via a high-performance graphics interface 639, using an interface circuit 692, which could be a PtP interface circuit. In alternative embodiments, any or all of the PtP links illustrated in FIG. 6 could be implemented as a multi-drop bus rather than a PtP link.

Chipset 690 may be in communication with a bus 620 via an interface circuit 696. Bus 620 may have one or more devices that communicate over it, such as a bus bridge 618 and I/O devices 616. Via a bus 610, bus bridge 618 may be in communication with other devices such as a keyboard/mouse 612 (or other input devices such as a touch screen, trackball, etc.), communication devices 626 (such as modems, network interface devices, or other types of communication devices that may communicate through a computer network 660), audio I/O devices 614, and/or a data storage device 628. Data storage device 628 may store code 630, which may be executed by processors 670 and/or 680. In alternative embodiments, any portions of the bus architectures could be implemented with one or more PtP links.

The computer system depicted in FIG. 6 is a schematic illustration of an embodiment of a computing system that may be utilized to implement various embodiments discussed herein. It will be appreciated that various components of the system depicted in FIG. 6 may be combined in a system-on-a-chip (SoC) architecture or in any other suitable configuration. For example, embodiments disclosed herein can be incorporated into systems including mobile devices such as smart cellular telephones, tablet computers, personal digital assistants, portable gaming devices, etc. It will be appreciated that these mobile devices may be provided with SoC architectures in at least some embodiments.

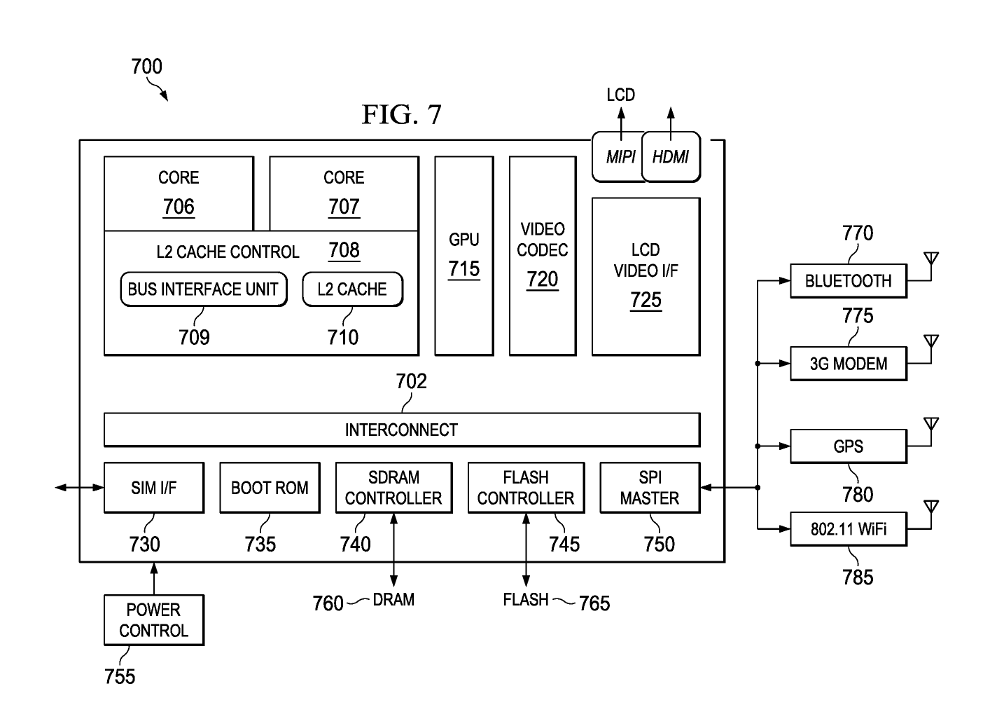

Turning to FIG. 7, FIG. 7 is a simplified block diagram associated with an example ecosystem SOC 700 of the present disclosure. At least one example implementation of the present disclosure can include the device pairing in a local network features discussed herein. Further, the architecture can be part of any type of tablet, smartphone (inclusive of Android™ phones, iPhones™), iPad™, Google Nexus™, Microsoft Surface™, personal computer, server, video processing components, laptop computer (inclusive of any type of notebook), Ultrabook™ system, any type of touch-enabled input device, etc. In an example, authentication engine 120 and process management cache 122 can be configured in the same or similar architecture as SOC 700.

In this example of FIG. 7, ecosystem SOC 700 may include multiple cores 706-707, an L2 cache control 708, a bus interface unit 709, an L2 cache 710, a graphics processing unit (GPU) 715, an interconnect 702, a video codec 720, and a liquid crystal display (LCD) I/F 725, which may be associated with mobile industry processor interface (MIPI)/high-definition multimedia interface (HDMI) links that couple to an LCD.

Ecosystem SOC 700 may also include a subscriber identity module (SIM) I/F 730, a boot read-only memory (ROM) 735, a synchronous dynamic random access memory (SDRAM) controller 740, a flash controller 745, a serial peripheral interface (SPI) master 750, a suitable power control 755, a dynamic RAM (DRAM) 760, and flash 765. In addition, one or more embodiments include one or more communication capabilities, interfaces, and features such as instances of Bluetooth™ 770, a 3G modem 775, a global positioning system (GPS) 780, and an 802.11 Wi-Fi 785.

In operation, the example of FIG. 7 can offer processing capabilities, along with relatively low power consumption to enable computing of various types (e.g., mobile computing, high-end digital home, servers, wireless infrastructure, etc.). In addition, such an architecture can enable any number of software applications (e.g., Android™, Adobe® Flash® Player, Java Platform Standard Edition (Java SE), JavaFX, Linux, Microsoft Windows Embedded, Symbian and Ubuntu, etc.). In at least one example embodiment, the core processor may implement an out-of-order superscalar pipeline with a coupled low-latency level-2 cache.

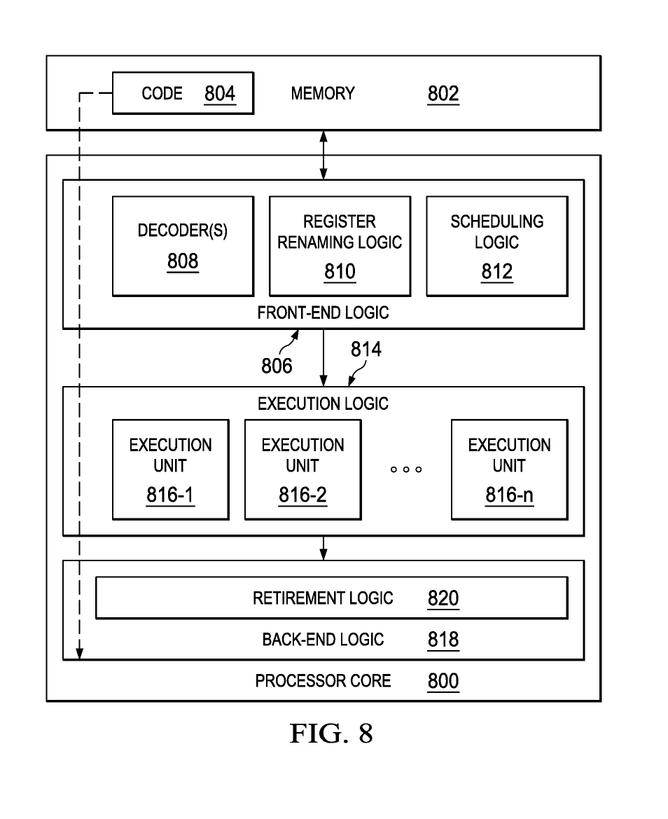

FIG. 8 illustrates a processor core 800 according to an embodiment. Processor core 800 may be the core for any type of processor, such as a micro-processor, an embedded processor, a digital signal processor (DSP), a network processor, or other device to execute code. Although only one processor core 800 is illustrated in FIG. 8, a processor may alternatively include more than one of the processor core 800 illustrated in FIG. 8. For example, processor core 800 represents one example embodiment of processors cores 874a, 874b, 884a, and 884b shown and described with reference to processors 870 and 880 of FIG. 8. Processor core 800 may be a single-threaded core or, for at least one embodiment, processor core 800 may be multithreaded in that it may include more than one hardware thread context (or “logical processor”) per core.

FIG. 8 also illustrates a memory 802 coupled to processor core 800 in accordance with an embodiment. Memory 802 may be any of a wide variety of memories (including various layers of memory hierarchy) as are known or otherwise available to those of skill in the art. Memory 802 may include code 804, which may be one or more instructions, to be executed by processor core 800. Processor core 800 can follow a program sequence of instructions indicated by code 804. Each instruction enters a front-end logic 806 and is processed by one or more decoders 808. The decoder may generate, as its output, a micro operation such as a fixed width micro operation in a predefined format, or may generate other instructions, microinstructions, or control signals that reflect the original code instruction. Front-end logic 806 also includes register renaming logic 810 and scheduling logic 812, which generally allocate resources and queue the operation corresponding to the instruction for execution.

Processor core 800 can also include execution logic 814 having a set of execution units 816-1 through 816-N. Some embodiments may include a number of execution units dedicated to specific functions or sets of functions. Other embodiments may include only one execution unit or one execution unit that can perform a particular function. Execution logic 814 performs the operations specified by code instructions.

After completion of execution of the operations specified by the code instructions, back-end logic 818 can retire the instructions of code 804. In one embodiment, processor core 800 allows out of order execution but requires in order retirement of instructions. Retirement logic 820 may take a variety of known forms (e.g., re-order buffers or the like). In this manner, processor core 800 is transformed during execution of code 804, at least in terms of the output generated by the decoder, hardware registers and tables utilized by register renaming logic 810, and any registers (not shown) modified by execution logic 814.

Although not illustrated in FIG. 8, a processor may include other elements on a chip with processor core 800, at least some of which were shown and described herein with reference to FIG. 6. For example, as shown in FIG. 6, a processor may include memory control logic along with processor core 800. The processor may include I/O control logic and/or may include I/O control logic integrated with memory control logic.

Note that with the examples provided herein, interaction may be described in terms of two, three, or more network elements. However, this has been done for purposes of clarity and example only. In certain cases, it may be easier to describe one or more of the functionalities of a given set of flows by only referencing a limited number of network elements. It should be appreciated that communication system 100 and its teachings are readily scalable and can accommodate a large number of components, as well as more complicated/sophisticated arrangements and configurations. Accordingly, the examples provided should not limit the scope or inhibit the broad teachings of communication system 100 as potentially applied to a myriad of other architectures.

It is also important to note that the operations in the preceding flow diagrams (i.e., FIGS. 4 and 5) illustrate only some of the possible correlating scenarios and patterns that may be executed by, or within, communication system 100. Some of these operations may be deleted or removed where appropriate, or these operations may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by communication system 100 in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although communication system 100 has been illustrated with reference to particular elements and operations that facilitate the communication process, these elements and operations may be replaced by any suitable architecture, protocols, and/or processes that achieve the intended functionality of communication system 100.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

### Other Notes and Examples

Example C1 is at least one machine readable storage medium having one or more instructions that when executed by at least one processor, cause the at least one processor to determine that an application begins to execute, receive credentials for the application, where the credentials are located in an immediate field of the application, receive a request from the application to access a secure resource, and block access to the secure resource if the credentials for the application do not allow the application to access the secure resource.

In Example C2, the subject matter of Example C1 can optionally include can optionally include where the instructions, when executed by the by at least one processor, further cause the at least one processor to verify the credentials for the application and store the verified credentials in a process management cache.

In Example C3, the subject matter of any one of Examples C1-C2 can optionally include where the credentials are verified by comparing the credentials for the application to credentials stored inside a boundary of the processor

In Example C4, the subject matter of any one of Examples C1-C3 can optionally include where the secure resource is a locker that the application access to store a state of the application.

In Example C5, the subject matter of any one of Examples C1-C4 can optionally include where the credentials are presented by instructions during process management by the at least one processor.

In Example C6, the subject matter of any one of Examples C1-05 can optionally include where the locker is a process control block.

In Example C7, the subject matter of any one of Examples C1-C6 can optionally include where the credentials include a public key and a private key.

In Example A1, an apparatus can include an authentication engine configured to determine that an application begins to execute, receive credentials for the application, where the credentials are located in an immediate field of the application, receive a request from the application to access a secure resource, and block access to the secure resource if the credentials for the application do not allow the application to access the secure resource.

In Example, A2, the subject matter of Example A1 can optionally include where the authentication engine is further configured to verify the credentials for the application and store the verified credentials in a process management cache.

In Example A3, the subject matter of any one of Examples A1-A2 can optionally include where the secure resource is a locker that the application access to store a state of the application.

In Example A4, the subject matter of any one of Examples A1-A3 can optionally include where the locker is a process control block.

In Example A5, the subject matter of any one of Examples A1-A4 can optionally include where the credentials include a public key and a private key.

Example M1 is a method including determining that an application begins to execute, receiving credentials for the application, where the credentials are located in an immediate field of the application, receiving a request from the application to access a secure resource, and blocking access to the secure resource if the credentials for the application do not allow the application to access the secure resource.

In Example M2, the subject matter of Example M1 can optionally include verifying the credentials for the application and storing the verified credentials in a process management cache.

In Example M3, the subject matter of any one of the Examples M1-M2 can optionally further include where the secure resource is a locker that the application access to store a state of the application.

In Example M4, the subject matter of any one of the Examples M1-M3 can optionally further include where the locker is a process control block.

In Example M5, the subject matter of any one of the Examples M1-M4 can optionally further include where the credentials include a public key and a private key.

Example S1 is a system for providing process management, the system comprising an authentication engine configured to determine that an application begins to execute, receive credentials for the application, where the credentials are located in an immediate field of the application, receive a request from the application to access a secure resource, and block access to the secure resource if the credentials for the application do not allow the application to access the secure resource.

In Example S2, the subject matter of Example S1 can optionally include where the authentication engine is further configured to verify the credentials for the application, and store the verified credentials in a process management cache.

In Example S3, the subject matter of any one of the Examples S1-S2 can optionally include where the secure resource is a locker that the application access to store a state of the application.

In Example S4, the subject matter of any one of the Examples S1-S3 can optionally include where the locker is a process control block.

In Example S5, the subject matter of any one of the Examples S1-S4 can optionally include where the credentials include a public key and a private key.

Example X1 is a machine-readable storage medium including machine-readable instructions to implement a method or realize an apparatus as in any one of the Examples A1-A5, or M1-M5. Example Y1 is an apparatus comprising means for performing of any of the Example methods M1-M5. In Example Y2, the subject matter of Example Y1 can optionally include the means for performing the method comprising a processor and a memory. In Example Y3, the subject matter of Example Y2 can optionally include the memory comprising machine-readable instructions.

What is claimed is:

1. At least one machine readable medium comprising one or more instructions that when executed by at least one processor, cause the at least processor to:
receive credentials for an application, wherein the credentials are located in an immediate field of the application;
receive a request from the application to access a secure resource; and
block access to the secure resource if the credentials for the application do not allow the application to access the secure resource.

2. The at least one machine readable medium of claim 1, further comprising one or more instructions that when executed by the at least one processor, further cause the at least one processor to:
verify the credentials for the application; and
store the verified credentials in a process management cache.

3. The at least one machine readable medium of claim 1, wherein the credentials are verified by comparing the credentials for the application to credentials stored inside a boundary of the at least one processor.

4. The at least one machine readable medium of claim 1, wherein the credentials are presented by instructions during process management by the at least one processor.

5. The at least one machine readable medium of claim 1, wherein the secure resource is a locker that the application accesses to store a state of the application.

6. The at least one machine readable medium of claim 5, wherein the locker is a process control block.

7. The at least one machine readable medium of claim 1, wherein the credentials include a public key and a private key.

8. An apparatus comprising:
an authentication engine configured to:
receive credentials for the application, wherein the credentials are located in an immediate field of the application;
receive a request from the application to access a secure resource; and
block access to the secure resource if the credentials for the application do not allow the application to access the secure resource.

9. The apparatus of claim 8, wherein the authentication engine is further configured to:
verify the credentials for the application; and
store the verified credentials in a process management cache.

10. The apparatus of claim 8, wherein the secure resource is a locker that the application accesses to store a state of the application.

11. The apparatus of claim 8, wherein the credentials include a public key and a private key.

12. A method comprising:
receiving credentials for the application, wherein the credentials are located in an immediate field of the application;
receiving a request from the application to access a secure resource; and
blocking access to the secure resource if the credentials for the application do not allow the application to access the secure resource.

13. The method of claim 12, further comprising:
verifying the credentials for the application; and
store the verified credentials in a process management cache.

14. The method of claim 12, wherein the secure resource is a process control block that the application accesses to store a state of the application.

15. The method of claim 12, wherein the credentials include a public key and a private key.

16. A system for process management, the system comprising:
an authentication engine configured to:
receive credentials for the application, wherein the credentials are located in an immediate field of the application;
receive a request from the application to access a secure resource; and
block access to the secure resource if the credentials for the application do not allow the application to access the secure resource.

17. The system of claim 16, wherein the authentication engine is further configured to:
verify the credentials for the application; and
store the verified credentials in a process management cache.

18. The system of claim 16, wherein the secure resource is a locker that the application accesses to store a state of the application.

19. The system of claim 18, wherein the locker is a process control block.

20. The system of claim 16, wherein the credentials include a public key and a private key.
